(19) United States
(12) Patent Application Publication
(10) Pub. No.: US 2015/0270566 A1
(43) Pub. Date: Sep. 24, 2015

(54) AIR COMPRESSOR AND FUEL CELL SYSTEM HAVING THE SAME

(71) Applicant: Hyundai Motor Company, Seoul (KR)

(72) Inventors: Changha Lee, Yongin (KR); Kyoungku Ha, Anyang (KR)

(21) Appl. No.: 14/547,911

(22) Filed: Nov. 19, 2014

(30) Foreign Application Priority Data
Mar. 24, 2014 (KR) 10-2014-0034288

(51) Int. Cl. H01M 8/06; F04D 29/42; F04D 29/58; F04D 29/28; H01M 8/24; F04D 17/10

(52) U.S. Cl. CPC H01M 8/0662; H01M 8/2465; F04D 17/10; F04D 29/582; F04D 29/284; F04D 29/4206; H01M 2250/20

(57) ABSTRACT

An air compressor for and a fuel cell system having the same are provided. The air compressor is configured to suction and compress air by rotating an impeller, and includes a volute case having an air inlet through which air is suctioned, and an air outlet through which compressed air is discharged. Particularly, in the air outlet, a coolant flow path is formed such that a coolant flows therethrough.

### CROSS-REFERENCE TO RELATED APPLICATION

This application claims priority to and the benefit of Korean Patent Application No. 10-2014-0034288 filed in the Korean Intellectual Property Office on Mar. 24 2014, the entire contents of which are incorporated herein by reference.

### TECHNICAL FIELD

The present invention relates to a fuel cell vehicle and an air cooling structure of an air compressor which is applied to a fuel cell system of the fuel cell vehicle.

### BACKGROUND

In general, in a fuel cell vehicle, a fuel cell system, which generates electrical energy by an electrochemical reaction between hydrogen and oxygen from the air using fuel cells, is provided as a power supply source for driving a drive motor.

The fuel cell system includes a stack having fuel cells stacked therewithin, a hydrogen supply system which supplies hydrogen to the stack, an air supply system which supplies air to the stack, and a cooling system which removes heat generated from the stack. Typically, the air supply system may include an air compressor which compresses air and supplies the compressed air to the stack, and a humidifier which humidifies the compressed air using moisture generated at the stack.

However, a temperature of the air compressed by the air compressor under an elevated power operational condition of the stack may rise to about 100 to 150° C. due to a high compression ratio and a substantial amount of air. The temperature of the compressed air may be greater than a normal operational temperature of the stack, for example, about 60 to 80° C., and thus may be disadvantageous to humidification efficiency of the humidifier and operational efficiency of the stack. Accordingly, it is necessary for the fuel cell system to cool the high-temperature compressed air that is supplied to the humidifier by the air compressor.

The above information disclosed in this Background section is merely for enhancement of understanding of the background of the invention and therefore it may contain information that does not form the prior art that is already known in this country to a person of ordinary skill in the art.

### SUMMARY

The present invention provides an air compressor which may cool a high-temperature compressed air supplied to a fuel cell stack using a simple configuration, and a fuel cell system including the air compressor.

In an exemplary embodiment of the present invention, an air compressor which suctions and compresses air by rotating an impeller is provided. The air compressor may include: a volute case having an air inlet through which air may be suctioned, and an air outlet through which compressed air may be discharged. In particular, a coolant flow path may be formed in the air outlet such that a coolant may flow therethrough.

Additionally, in the air compressor according to an exemplary embodiment of the present invention, the volute case may include a coolant circulation housing having a coolant inlet into which the coolant may flow, and a coolant outlet through which the coolant may be discharged, and may be installed on an outer circumference of the air outlet. Moreover, in the air compressor according to an exemplary embodiment of the present invention, the coolant flow path may be formed between the coolant circulation housing and the outer circumference of the air outlet in the volute case.

Furthermore, in the air compressor according to an exemplary embodiment of the present invention, a plurality of cooling fins may be formed on an inner circumference of the air outlet which may correspond to the coolant circulation housing. The cooling fins may be disposed to be spaced apart from each other at predetermined intervals in an inner circumferential direction of the air outlet, and may be formed to be elongated in a stream direction of the compressed air.

In another aspect, the present invention provides a fuel cell system that may include: a stack in which fuel cells are stacked; a hydrogen supply unit configured to supply hydrogen to the stack; and an air supply unit configured to supply air to the stack, in which the air supply unit may include the aforementioned air compressor. In addition, in the fuel cell system according to an exemplary embodiment of the present invention, the air supply unit may include a humidifier connected to the stack and the air compressor.

In addition, the fuel cell system may include: a stack in which fuel cells may be stacked;

a hydrogen tank configured to supply hydrogen to the stack; an air compressor configured to suction and compress air, supply compressed air to the stack through a humidifier, and form a coolant flow path at an air discharge side; and an air cooling loop configured to allow a coolant to circulate to the coolant flow path through an electrical cooling system.

The air compressor may include a volute case having an air inlet through which air may be suctioned, and an air outlet through which the compressed air may be discharged. Moreover, the coolant flow path may be disposed at the air outlet. The volute case may include: a coolant circulation housing having a coolant inlet into which the coolant may flow; and a coolant outlet through which the coolant may be discharged. The volute case may be installed on an outer circumference of the air outlet.

In the fuel cell system according to an exemplary embodiment of the present invention, the coolant flow path may be formed between the coolant circulation housing and the outer circumference of the air outlet. The air cooling loop may connect the electrical cooling system with the coolant flow path through a coolant line. In addition, the air cooling loop may connect the electrical cooling system with the coolant inlet and the coolant outlet through the coolant line.

### BRIEF DESCRIPTION OF THE DRAWINGS

The above and other objects, features and advantages of the present invention will be more clearly understood from the following detailed description taken in conjunction with the accompanying drawing.

FIG. 1 illustrates an exemplary fuel cell system to which an exemplary air compressor is applied according to an exemplary embodiment of the present invention.

FIG. 2 illustrates an exemplary air compressor for an exemplary fuel cell system according to an exemplary embodiment of the present invention.

FIG. 3 illustrates a front view of an exemplary air compressor for an exemplary fuel cell system according to an exemplary embodiment of the present invention.

FIG. 4 illustrates a cross-sectional view of an exemplary air compressor taken along line W-IV of FIG. 3 according to an exemplary embodiment of the present invention.

FIG. 5 illustrates a cross-sectional view of an exemplary air compressor taken along line V-V of FIG. 3 according to an exemplary embodiment of the present invention.

FIG. 6 illustrates an exemplary operation process of of an exemplary fuel cell system to which an exemplary air compressor is applied according to an exemplary embodiment of the present invention.

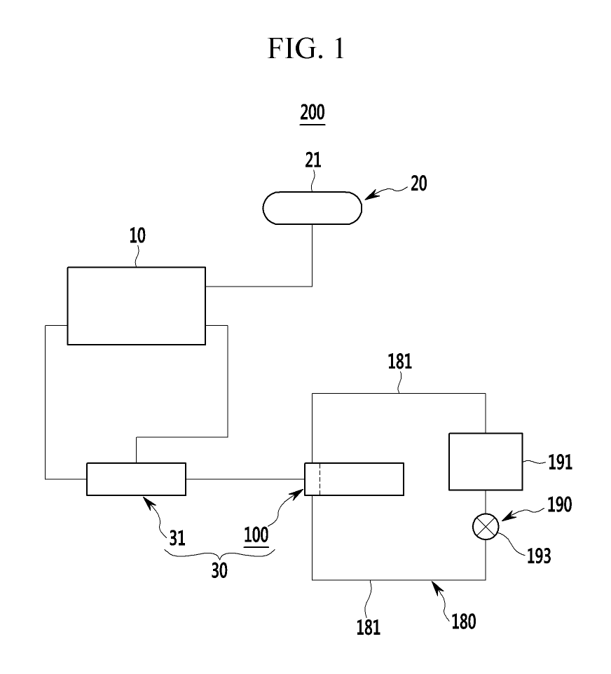

Reference numerals set forth in the FIGS. 1-6 include reference to the following elements as further discussed below: 10 . . . Stack

20 . . . Hydrogen supply unit

21 . . . Hydrogen tank

30 . . . Air supply unit

31 . . . Humidifier

100 . . . Air compressor

110 . . . Impeller

130 . . . Volute case

131 . . . Air inlet

133 . . . Air outlet

151 . . . Coolant flow path

160 . . . Coolant circulation housing

161 . . . Coolant inlet

163 . . . Coolant outlet

171 . . . Cooling fin

180 . . . Air cooling loop

181 . . . Coolant line

190 . . . Electrical cooling system

191 . . . Coolant reservoir

193 . . . Coolant pump

200 . . . Fuel cell system

### DETAILED DESCRIPTION OF THE EMBODIMENTS

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention.

A part irrelevant to the description will be omitted to clearly describe the present invention, and the same or similar constituent elements will be designated by the same reference numerals throughout the specification. The size and thickness of each component illustrated in the drawings are arbitrarily shown for understanding and ease of description, but the present invention is not limited thereto. Thicknesses of several portions and regions are enlarged for clear expressions. Further, in the following detailed description, names of constituents, which are in the same relationship, are divided into “the first”, “the second”, and the like, but the present invention is not necessarily limited to the order in the following description.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In addition, “unit”, “means”, “part”, “member”, or the like, which is described in the specification, means a unit of a comprehensive configuration that performs at least one function or operation.

FIG. 1 illustrates an exemplary fuel cell system to which an exemplary air compressor is applied according to an exemplary embodiment of the present invention. Referring to FIG. 1, an air compressor 100 according to an exemplary embodiment of the present invention may be applied to a fuel cell system 200 that produces electrical energy by an electrochemical reaction between hydrogen and air.

For example, the fuel cell system 200 according to an exemplary embodiment of the present invention may be applied to a fuel cell vehicle that operates a drive motor using electrical energy and operates wheels using driving power of the drive motor. The fuel cell system 200 may include: a stack 10; a hydrogen supply unit 20; and an air supply unit 30. The stack 10, the hydrogen supply unit 20, and the air supply unit 30 may be executed by a controller. The stack 10 is an electricity generating assembly of fuel cells having air electrodes and fuel electrodes. The stack 10 may be supplied with hydrogen from the hydrogen supply unit 20, and air (e.g., oxygen) from the air supply unit 30, to generate electrical energy by an electrochemical reaction between hydrogen and oxygen.

Further, the hydrogen supply unit 20 may include a hydrogen tank 21 configured to store hydrogen gas and supply hydrogen gas to the stack 10. The air supply unit 30 may include the air compressor 100 configured to suction and compress air, and supply the compressed air to the stack 10. Furthermore, the air supply unit 30 may include a humidifier 31 configured to humidify the compressed air supplied from the air compressor 100 using moisture discharged from the air electrode of the stack 10, and supply the humidified air to the air electrode of the stack 10. In an exemplary embodiment of the present invention, the air compressor 100 may be configured to suction and compress air, and supply the compressed air to the humidifier 31, by rotating an impeller 110. The air compressor 100 may be applied to a general vehicle, a hybrid vehicle, an electric vehicle, and the like.

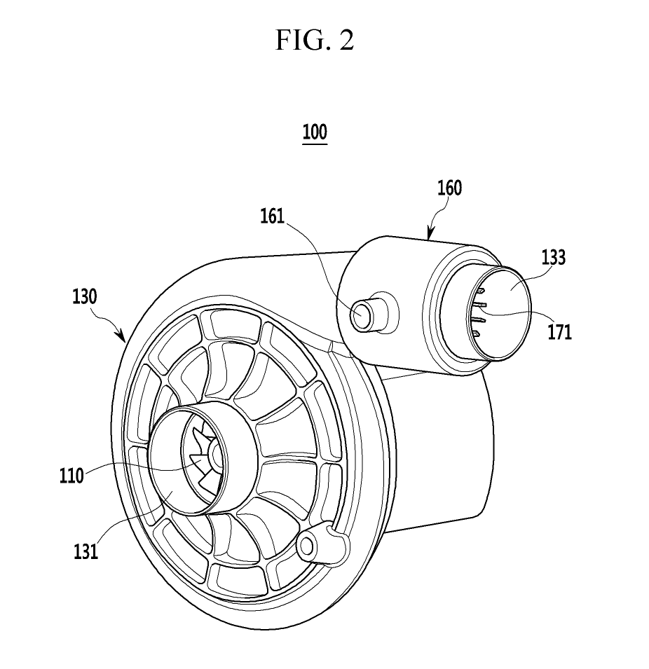

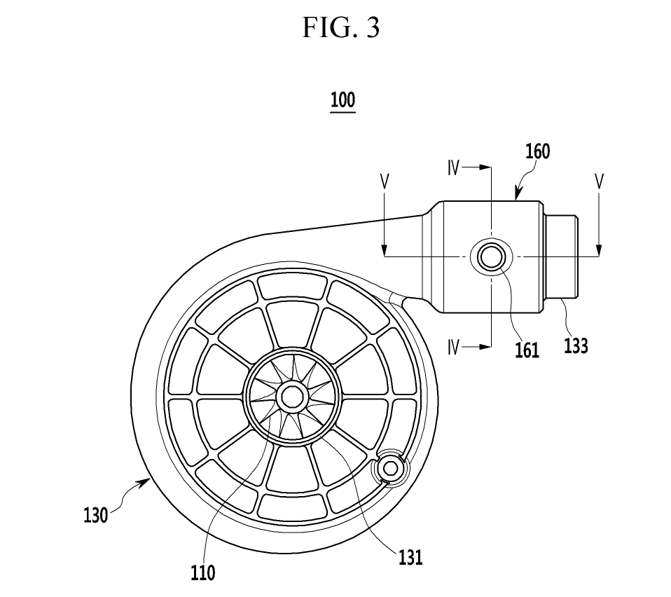

Hereinafter, the air compressor included in an exemplary fuel cell system 200 of an exemplary fuel cell vehicle will be described as an example. However, it should be understood that the scope of the present invention is not necessarily limited thereto, and the technical spirit of the present invention may be applied to air compressors adopted for various types of air supply structures for various uses. Hereinafter, a configuration of the air compressor 100 for a fuel cell system according to an exemplary embodiment of the present invention will be described in detail with reference to FIGS. 2 and 3.

The air compressor 100 may have a structure in which the compressed air may be cooled at a side where air is discharged using a simple configuration to prevent the compressed air compressed at an elevated temperature (e.g., a predetermined temperature) from flowing into the humidifier 31. Particularly, in an exemplary embodiment of the present invention, the air compressor 100 for a fuel cell system may be configured to decrease a discharge temperature of the compressed air to prevent humidification efficiency of the humidifier 31 and operational performance of the stack 10 from deteriorating.

FIG. 2 illustrates the air compressor for a fuel cell system according to the exemplary embodiment of the present invention, and FIG. 3 illustrates a front view of the air compressor for a fuel cell system according to an exemplary embodiment of the present invention. Referring to FIGS. 2 and 3, the air compressor 100 may include a volute case 130 having a volute shape, or alternatively a vortex shape, or a screw shape.

The volute case 130 may have an air inlet 131 through which air may be suctioned, and an air outlet 133 through which the compressed air may be discharged. The aforementioned impeller 110 may be installed within the volute case 130. The impeller 110 may be rotatably installed within the volute case 130 by a drive shaft (not illustrated), and installed between a suction path of air and a discharge path of the compressed air.

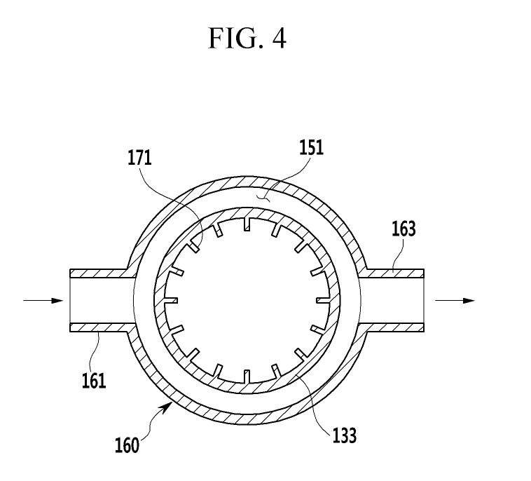

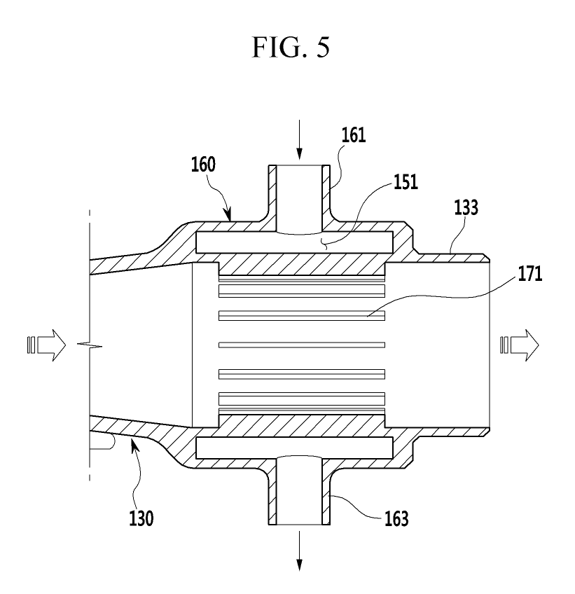

FIG. 4 illustrates a cross-sectional view of an exemplary air compressor taken along line IV-IV of FIG. 3, and FIG. 5 illustrates a cross-sectional view of an exemplary air compressor taken along line V-V of FIG. 3. Referring to FIGS. 2 to 4, in an exemplary embodiment of the present invention, the air outlet 133 of the volute case 130 may have a coolant flow path 151 that allows a coolant to flow to reduce a discharge temperature of the compressed air.

When the coolant flow path 151 is formed around the air outlet 133, the volute case 130 may include a coolant circulation housing 160 which may be installed at an outer circumference side of the air outlet 133 according to an exemplary embodiment of the present invention. The coolant circulation housing 160 may have an inner diameter greater than an outer diameter of the air outlet 133, and may be fixed on the outer circumference of the air outlet 133. The coolant circulation housing 160 may form a passage having a predetermined space between an inner diameter surface of the coolant circulation housing 160 and an outer diameter surface of the air outlet 133.

For example, the coolant circulation housing 160 may have a shape having a wall that may be bent from both ends of a cylindrical body thereof toward the outer circumference of the air outlet 133, and may form the passage between the inner diameter surface of the coolant circulation housing 160 and the outer diameter surface of the air outlet 133. Therefore, in an exemplary embodiment of the present invention, a coolant flow path 151 may be formed between the inner diameter surface of the coolant circulation housing 160 and the outer diameter surface of the air outlet 133 within the volute case 130. In particular, the coolant flow path may be a passage through which the coolant flows.

In addition, a coolant inlet 161 into which the coolant may flow and a coolant outlet 163 through which the coolant may be discharged may be formed in the coolant circulation housing 160. The coolant may flow in through the coolant inlet 161 and may flow along the coolant flow path 151, and then may be discharged through the coolant outlet 163. Accordingly, the air compressor 100 may have the coolant flow path 151, which may pass through the coolant circulation housing 160. Further, the flow path 151 may be formed around the air outlet 133 through which the compressed air is discharged, to reduce a discharge temperature of the compressed air by the coolant that circulates along the coolant flow path 151.

Moreover, in an exemplary embodiment of the present invention, to further improve cooling efficiency of the compressed air being discharged through the air outlet 133, a plurality of cooling fins 171 may be formed on an inner circumference of the air outlet 133 which correspond to the coolant circulation housing 160. The cooling fins 171 may achieve heat exchange between the coolant flowing along the coolant flow path 151 and the compressed air discharged through the air outlet 133. The cooling fins 171 may be formed to protrude on the inner circumference of the air outlet 133. In particular, the cooling fins 171 may be disposed to be spaced apart from each other at predetermined intervals in an inner circumferential direction of the air outlet 133, and may be formed to be elongated in a stream direction of the compressed air.

In an exemplary embodiment of the present invention, a flow rate of the coolant flowing along the coolant flow path 151, and the number, size, and length of the cooling fins 171 may vary depending on a temperature and pressure of the compressed air, and are not limited to specific values. In addition, the fuel cell system 200 to which the air compressor 100 is applied may include an air cooling loop 180 that allows the coolant to circulate in the coolant flow path 151 of the air outlet 133 to cool the compressed air being discharged through the air outlet 133 of the air compressor 100.

In an exemplary embodiment of the present invention, the air cooling loop 180 may be formed by an electrical cooling system 190 for cooling exothermic components such as electrical components of the fuel cell vehicle, for example, a motor, and an inverter. The electrical cooling system 190 may include a coolant reservoir 191 configured to store the coolant, and a coolant pump 193 configured to supply the coolant stored in the coolant reservoir 191 to the electrical components of the fuel cell vehicle. The electrical cooling system 190 may be formed as an electrical cooling system in the fuel cell vehicle as described in the related arts.

The air cooling loop 180 may connect the coolant reservoir 191 of the electrical cooling system 190 to the aforementioned coolant flow path 151 through a coolant line 181. In other words, the air cooling loop 180 may connect the coolant reservoir 191 with the coolant inlet 161 and the coolant outlet 163 of the coolant circulation housing 160 through the coolant line 181.

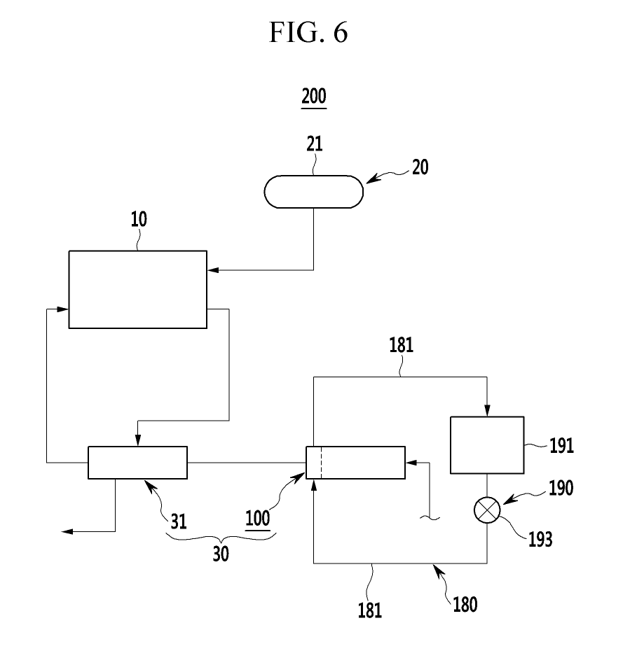

Hereinafter, an exemplary operation process of the fuel cell system 200 to which the air compressor 100 in an exemplary embodiment of the present invention is applied will be described in detail with reference to the previously disclosed drawings and the following drawing. FIG. 6 illustrates an exemplary operation process of an exemplary fuel cell system to which an exemplary air compressor according to the exemplary embodiment of the present invention is applied.

As shown in the above described drawings and FIG. 6, first, in the exemplary embodiment of the present invention, when the fuel cell system 200 is operated, hydrogen stored in the hydrogen tank 21 of the hydrogen supply unit 20 may be supplied to the stack 10, and the compressed air may be supplied to the stack 10 by the air compressor 100 of the air supply unit 30. The air compressor 100 may be configured to suction air through the air inlet 131 of the volute case 130 by rotating the impeller 110, compress the intake air, and discharge the compressed air through the air outlet 133. In particular, the air compressed by the air compressor 100 may be supplied to the humidifier 31 of the air supply unit 30 through the air supply line, and the humidifier 31 may be configured to humidify the compressed air using moisture generated at the air electrode of the stack 10, and supply the humidified air to the air electrode of the stack 10.

Meanwhile, a temperature of the air compressed by the air compressor 100 under an elevated power operational condition of the stack 10 may rise to about 100 to 150° C. due to an increased compression ratio and a substantial amount of air. In an exemplary embodiment of the present invention, the temperature of the compressed air being discharged through the air outlet 133 of the volute case 130 may be reduced.

Accordingly, in an exemplary embodiment of the present invention, the coolant of the electrical cooling system 190 may circulate to the aforementioned coolant flow path 151 of the air outlet 133 through the air cooling loop 180. In other words, the coolant supplied from the coolant reservoir 191 of the electrical cooling system 190 may flow and circulate along the coolant flow path 151 of the air outlet 133 through the coolant line 181 of the air cooling loop 180.

In particular, the coolant may flow into the coolant flow path 151 through the coolant inlet 161 of the coolant circulation housing 160, may flow along the coolant flow path 151, and may be discharged through the coolant outlet 163. Accordingly, the coolant may circulate through the coolant flow path 151 at the air outlet 133 through which the elevated temperature compressed air may be discharged, to reduce the discharge temperature of the compressed air by heat exchange between the coolant and the compressed air.

Further, in an exemplary embodiment of the present invention, the plurality of cooling fins 171 may be formed on the inner circumference of the air outlet 133, to increase a contact area of the compressed air to the air outlet 133. Accordingly, in an exemplary embodiment of the present invention, the contact area of the compressed air to the air outlet 133 may increase by the cooling fins 171, thereby further improving heat exchange performance between the coolant flowing along the coolant flow path 151 and the compressed air being discharged through the air outlet 133.

The compressed air discharged through the air outlet 133 of the air compressor 100 and having the reduced temperature by the heat exchange with the coolant as described above may be supplied to the humidifier 31 through the air supply line. Due to the air compressor 100 and the fuel cell system 200 having the air compressor 100 as described above, the coolant may circulate through the coolant flow path 151 at the air outlet 133 of the air compressor 100, thereby reducing the temperature of the compressed air being discharged through the air outlet 133.

Therefore, in various exemplary embodiments of the present invention, the elevated temperature compressed air may be prevented from being supplied to the humidifier 31 to increase humidification efficiency and durability of the humidifier 31 by preventing damage to a material of the humidifier 31 and increasing relative humidity of the compressed air. In addition, in various exemplary embodiments of the present invention, a temperature of the compressed air may be optimized for a normal operation of the stack 10 (e.g. operation without error), thereby improving operational performance of the stack 10.

Furthermore, in various exemplary embodiments of the present invention, the coolant flow path 151 for cooling the compressed air may be formed around the air outlet 133 of the air compressor 100, and consequently, a separate heat exchanger or an air cooler may be omitted to cool the compressed air. Accordingly, the may provide a simplified configuration of the entire fuel cell system 200, and costs may be reduced, and may further provide an advantage in terms of layout design of a vehicle by ensuring an additional space.

While this invention has been described in connection with what is presently considered to be various exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. An air compressor configured to suction and compress air by rotating an impeller, comprising:
a volute case including an air inlet through which air is suctions and an air outlet through which compressed air is discharged,
wherein a coolant flow path is formed in the air outlet such that a coolant flows therethrough.

2. The air compressor of claim 1, wherein the volute case includes:
a coolant circulation housing having a coolant inlet into which the coolant flows; and
a coolant outlet through which the coolant is discharged and is installed on an outer circumference of the air outlet.

3. The air compressor of claim 2, wherein the coolant flow path is formed between the coolant circulation housing and the outer circumference of the air outlet in the volute case.

4. The air compressor of claim 3, wherein a plurality of cooling fins formed on an inner circumference of the air outlet to correspond to the coolant circulation housing.

5. The air compressor of claim 4, wherein the cooling fins are disposed to be spaced apart from each other at predetermined intervals in an inner circumferential direction of the air outlet and formed to be elongated in a stream direction of the compressed air.

6. A fuel cell system, comprising:
a stack having fuel cells stacked therein;
a hydrogen supply unit configured to supply hydrogen to the stack; and
an air supply unit configured to supply air to the stack,
wherein the air supply unit includes the air compressor of claim 1.

7. The fuel cell system of claim 6, wherein the air supply unit includes a humidifier which is connected with the stack and the air compressor.

8. A fuel cell system, comprising:
a stack in which fuel cells are stacked;
a hydrogen tank configured to supply hydrogen to the stack;
an air compressor configured to suction and compress air, supply the compressed air to the stack through a humidifier, and form a coolant flow path at an air discharge side; and
an air cooling loop which allows a coolant to circulate to the coolant flow path through an electrical cooling system.

9. The fuel cell system of claim 8, wherein the air compressor includes a volute case having an air inlet through which air is suctioned and an air outlet through which the compressed air is discharged, and the coolant flow path is disposed at the air outlet.

10. The fuel cell system of claim 9, wherein the volute case includes a coolant circulation housing which has a coolant inlet into which the coolant flows, and a coolant outlet through which the coolant is discharged, and the volute case is installed on an outer circumference of the air outlet.

11. The fuel cell system of claim 10, wherein the coolant flow path is formed between the coolant circulation housing and the outer circumference of the air outlet.

12. The fuel cell system of claim 8, wherein the air cooling loop connects the electrical cooling system with the coolant flow path through a coolant line.

13. The fuel cell system of claim 10, wherein the air cooling loop connects the electrical cooling system with the coolant inlet and the coolant outlet through a coolant line.
